(19) United States
(12) Patent Application Publication
(10) Pub. No.: US 2026/0348344 A1
(43) Pub. Date: Nov. 5, 2026

(54) FUEL INJECTOR

(71) Applicant: PHINIA DELPHI LUXEMBOURG SARL, Belvaux (LU)

(72) Inventor: Michael Peter Cooke, Rochester (GB)

(21) Appl. No.: 19/124,617

(22) PCT Filed: Oct. 31, 2023
(86) PCT No.: PCT/EP2023/080435

§ 371 Date: Apr. 25, 2025

(30) Foreign Application Priority Data
Nov. 1, 2022 (GB) 2216228.3

(51) Int. Cl. F02M 21/02

(52) U.S. Cl. CPC F02M 21/0266; F02M 21/0254

(57) ABSTRACT

A fuel injector for delivering gaseous fuel to an internal combustion engine includes: an injection nozzle including a nozzle body provided with a nozzle bore; a valve needle assembly received within the nozzle bore and including a valve needle engageable with a seat region to control gaseous fuel delivery through at least one outlet of the injection nozzle; a valve needle coupling member that is engageable with the valve needle assembly to cause an opening movement of the valve needle; a first actuator that is operable to produce a first opening force that acts on the valve needle assembly through engagement between the first actuator and the valve needle coupling member; and a second actuator that is operable to produce a second opening force that acts on the valve needle assembly through engagement between the second actuator and the valve needle coupling member. The valve needle coupling member is movable relative to the second actuator when the second actuator is inactive. The valve needle coupling member defines a separation distance with an engagement surface of the valve needle assembly so that the valve needle coupling member only impacts the engagement surface when the valve needle coupling member has moved through the separation distance following actuation, whereby the valve needle coupling member and the engagement surface remain engaged through a full range of movement of the valve needle to a full lift position.

### FIELD OF THE INVENTION

This invention relates to a fuel injector for use in a gaseous fuel injection system. In particular, the invention relates to a fuel injector for gaseous fuel such as hydrogen for delivering fuel to an internal combustion engine.

### BACKGROUND

In fuel injection systems for liquid fuel, it is known for a fuel pump to supply fuel to a high-pressure accumulator (or common rail), from where it is delivered into each cylinder of the engine by means of a dedicated fuel injector. Typically, a fuel injector has an injection nozzle that is received within a bore provided in a cylinder head of the cylinder, and a valve needle which is actuated to control the release of high-pressure fuel into the cylinder from spray holes provided in the injection nozzle.

One simple way of opening and closing a valve needle is to couple a solenoid actuator directly to the valve needle, by attaching an armature of the actuator to the valve needle (or by providing a valve needle with an integral armature). The valve needle is biased towards a seating surface so that, when the solenoid is not energised, the valve needle prevents fuel flow through the spray holes. When the solenoid is actuated, the valve needle is lifted away from its seating surface and fuel injection takes place.

Fuel injectors and injection systems may be configured in a similar manner for use with gaseous fuel, such as hydrogen. In this case, the hydrogen is typically held at high pressure in a storage tank of the vehicle, for example up to 700 bar. Meanwhile, the injectors may operate at approximately 300 bar, for example. So, it may be possible for fuel to be delivered directly from the tank to the fuel injectors, thereby obviating the need for an accumulator. A complication with this approach, however, is that the fuel pressure reduces as the tank is depleted. For example, the fuel pressure may drop to 150 bar or lower as the tank empties. As the force required to open the valve needle is influenced by the fuel pressure, it follows that the opening force varies according to the filling state of the tank.

It is against this background that the invention has been devised.

### SUMMARY OF THE INVENTION

An aspect of the invention provides a fuel injector for delivering gaseous fuel to an internal combustion engine. The fuel injector comprises: an injection nozzle comprising a nozzle body provided with a nozzle bore; a valve needle assembly received within the nozzle bore and including a valve needle engageable with a seat region to control gaseous fuel delivery through at least one outlet of the injection nozzle; a valve needle coupling member that is engageable with the valve needle assembly to cause an opening movement of the valve needle; a first actuator that is operable to produce a first opening force that acts on the valve needle assembly through engagement between the first actuator and the valve needle coupling member; and a second actuator that is operable to produce a second opening force that acts on the valve needle assembly through engagement between the second actuator and the valve needle coupling member.

The valve needle coupling member is movable relative to the second actuator when the second actuator is inactive. The valve needle coupling member defines a separation distance with an engagement surface of the valve needle assembly so that the valve needle coupling member only impacts the engagement surface when the valve needle coupling member has moved through the separation distance following actuation, whereby the valve needle coupling member and the engagement surface remain engaged through a full range of movement of the valve needle to a full lift position.

The second actuator may be configured so that the second opening force urges the second actuator into engagement with the valve needle coupling member.

The second actuator may comprise a first thrust surface that is configured to engage a second thrust surface that is fixed relative to the valve needle coupling member. Optionally, the valve needle coupling member comprises the second thrust surface.

The second actuator may comprise a second armature, in which case the valve needle coupling member is movable relative to the second armature when the second actuator is inactive. The first thrust surface may be fixed relative to the second armature. For example, the first thrust surface may be defined by a surface of a component attached to the second armature.

The second actuator may be configured to decouple from the valve needle coupling member when inactive.

The first actuator may be fixed to the valve needle coupling member.

The first actuator may comprise a first armature that is carried by the valve needle coupling member. In such embodiments, the fuel injector may comprise a first stop member which defines a first stop surface with which the first armature is brought into engagement when the valve needle is brought to close against the seat region. The first stop member optionally further defines an abutment surface for a spring that serves to urge the valve needle against the seat region to close the valve needle when the first actuator and the second actuator are de-actuated. The stop member may also be formed from a damping material so that the stop member absorbs movement of the first armature as it is brought into engagement with the stop member.

The valve needle coupling member may be a pull tube within which a portion of the valve needle is received. The pull tube may define a flow path for gaseous fuel through the injection nozzle. The pull tube may be provided with at least one opening to allow gaseous fuel flowing within the pull tube to flow radially out through the pull tube for delivery to downstream parts of the injection nozzle.

The valve needle coupling member may define an internal engagement surface which is engageable with the engagement surface of the valve needle assembly. The internal engagement surface of the valve needle coupling member and the engagement surface of the valve needle assembly may be frusto-conical surfaces.

The engagement surface of the valve needle assembly may be defined by a lift member carried on the valve needle. The lift member may be a tubular part carried on the valve needle.

The fuel injector may further comprise first and second stop surfaces for the first and second armatures, respectively, with which the first and second armatures may engage when the valve needle moves into the full lift position.

Another aspect of the invention provides a method of operating a fuel injector for delivering gaseous fuel to an internal combustion engine. The fuel injector comprises: an injection nozzle comprising a nozzle body provided with a nozzle bore; a valve needle assembly received within the nozzle bore and including a valve needle engageable with a seat region to control gaseous fuel delivery through at least one outlet of the injection nozzle; and a valve needle coupling member that is engageable with the valve needle assembly to cause an opening movement of the valve needle. The valve needle coupling member defines a separation distance with an engagement surface of the valve needle assembly so that the valve needle coupling member only impacts the engagement surface when the valve needle coupling member has moved through the separation distance following actuation, whereby the valve needle coupling member and the engagement surface remain engaged through a full range of movement of the valve needle to a full lift position. The method comprises operating a first actuator of the injector to produce a first opening force that acts on the valve needle assembly through engagement between the first actuator and the valve needle coupling member. The method further comprises: when a pressure of fuel exceeds a pressure threshold, operating a second actuator of the injector to produce a second opening force that acts on the valve needle assembly through engagement between the second actuator and the valve needle coupling member; and when a pressure of fuel is below the pressure threshold, moving the valve needle coupling member relative to the second actuator.

It will be appreciated that the various features of each aspect of the invention are equally applicable to, alone or in appropriate combination, the other aspects of the invention also.

### BRIEF DESCRIPTION OF THE DRAWINGS

In order that the invention may be more readily understood, preferred non-limiting embodiments thereof will now be described, by way of example only, with reference to the accompanying drawings, in which:

FIG. 1 is a cross-sectional view of a fuel injector of an embodiment of the invention;

FIGS. 2 to 4 show successive stages of injection for the fuel injector of FIG. 1 when the injector is in a high-pressure mode; and

FIG. 5 corresponds to FIG. 1 but shows a valve needle of the injector fully lifted away from its valve seat when the injector is in a low-pressure mode.

In the drawings, as well as in the following description, like features are assigned like reference signs.

### SPECIFIC DESCRIPTION

Throughout this description, terms such as ‘top’, ‘bottom’, ‘upper’ and ‘lower’, and other directional references, are used with reference to the orientation of the fuel injector as shown in the accompanying drawings. However, it will be appreciated that such references are not limiting and that fuel injectors according to the invention could be used in any orientation.

### DETAILED DESCRIPTION OF THE INVENTION

In general terms, embodiments of the invention provide fuel injectors for gaseous fuel for use in internal combustion engines, in which a variable opening force can be applied to a valve member of the injector to account for variation in the force required to open the valve member due to fluctuations in fuel pressure.

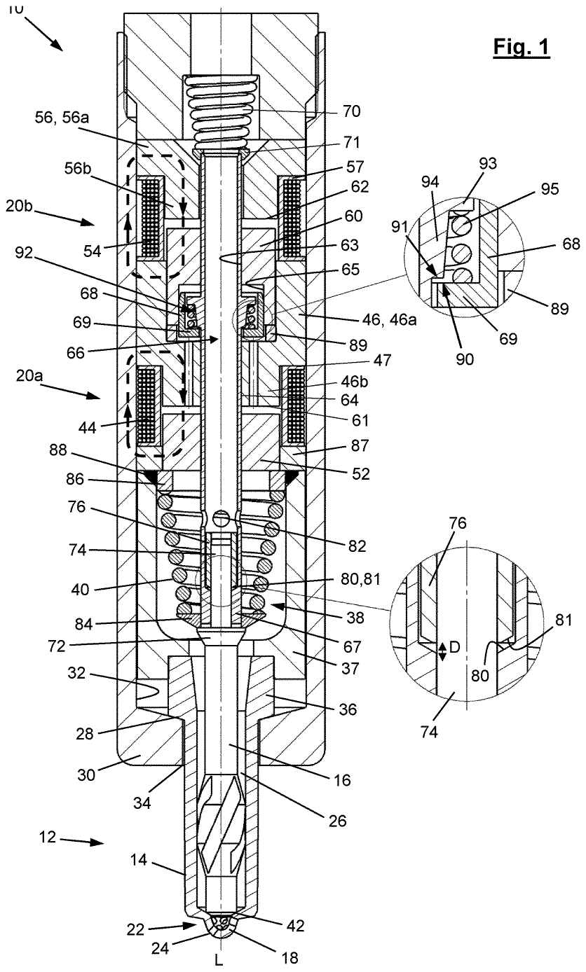

FIG. 1 shows a first embodiment of a fuel injector 10 for gaseous fuel for use in an internal combustion engine. The fuel injector 10 is of the inwardly-opening type and comprises an injection nozzle 12 having a substantially cylindrical nozzle body 14, through which a valve needle 16 of a valve needle assembly extends downwardly towards a nozzle tip 18.

The fuel injector also includes an actuator arrangement, referred to generally as 20, for the injection nozzle 12. The injector 10 has a longitudinal axis L and the injection nozzle 12, and hence the valve needle 16, extend along the longitudinal axis L.

The nozzle tip 18 defines a sac volume 22 which receives gaseous fuel in use for delivery to the combustion chamber of the engine (not shown). In the region of the sac volume 22, the wall of the nozzle body 14 is provided with a plurality of nozzle outlets 24, which extend through the thickness of the walls of the nozzle body 14 to enable fluid communication between a nozzle bore 26 and the environment external to the fuel injector 10 (i.e. the combustion chamber). Three nozzle outlets 24 are fully visible in the figures, with three more partially visible, due to the cross-sectional view, but it will be appreciated that the set of nozzle outlets 24 may comprise any suitable number of such outlets, and potentially a single outlet.

At the opposite end of the injection nozzle 12 to the nozzle tip 18, the nozzle body 14 defines a shoulder region 28, which has an increased outer diameter when compared to the rest of the nozzle body 14. The nozzle body 14 is received within a tubular housing 30 which defines an internal bore 32, which receives the other parts of the injector 10 also. The shoulder region 28 is engaged with a step in the internal surface of the tubular housing 30 and the elongate stem of the nozzle body 14 extends and protrudes through an opening 34 at a lower end of the housing 30.

An enlarged head end 36 of the nozzle body 14, remote from the tip 18, is received within an insert 37 located within a lower section of the tubular housing 30. The insert 37 defines a spring chamber 38, which houses a nozzle spring 40 for biassing the valve needle 16 into engagement with a valve needle seat 42. The nozzle spring 40 is configured to provide a relatively high force, to counteract the force generated on the relatively large seat region 42 by high pressure in the combustion chamber.

The valve needle assembly is operable to control fuel delivery through the nozzle outlets 24. The valve needle 16 is received within the nozzle bore 26 and is engageable with a seat region 42, which is defined by a frusto-conical surface of the nozzle bore 26 of the injection nozzle 10.

With the valve needle 16 engaged with the seat region 42, this defines a ‘closed’ position of the valve needle 16, with fuel being prevented from flowing out of the fuel injector 10 through the nozzle outlets 24. In contrast, an ‘open’ position of the valve needle 16 is defined when the valve needle 16 is moved away from the seat region 42, with fuel consequently being allowed to flow out of the nozzle outlets 24 via the nozzle bore 26 by means of flats, slots or grooves provided on the surface of the valve needle 16.

Further description of the operation of the fuel injector 10 will follow later.

Within the upper section of the housing 30, first and second actuators, hereafter referred to as first and second actuator arrangements 20a, 20b are arranged in axial series along the longitudinal axis L of the fuel injector 10, the first actuator arrangement 20a being below the second actuator arrangement 20b in the orientation shown in FIG. 1.

The first actuator arrangement 20a comprises a solenoid defining a first coil 44, which is arranged concentrically around a first core member 46 in a radially outer region of the first actuator arrangement 20a. The first coil 44 is mounted on a first coil-former 47 in a known manner. The first actuator arrangement 20a further comprises a first armature 52, which is arranged to move axially upwardly to engage the first core member 46 when the first coil 44 is energised.

Correspondingly, the second actuator arrangement 20b comprises a solenoid defining a second coil 54, which is arranged concentrically around a second core member 56 in a radially outer region of the second actuator arrangement 20b. The second coil 54 is mounted on a second coil-former 57 in a known manner. The second actuator arrangement 20b further comprises a second armature 60, which is arranged to move axially upwardly to engage the second core member 56 when the second coil 54 is energised.

Each core member 46, 56 comprises an upper region 46a, 56a and a lower region 46b, 56b, with the lower regions 46b, 56b protruding into the space encircled by the respective coil 44, 54 and therefore being located radially inward of the respective coil 44, 54. The lower region 46b, 56b of each core member 46, 56 has a planar underside defining a top stop surface 61, 62 that limits upward movement of the respective one of the armatures 52, 60, as will be described in further detail below.

The valve needle assembly also includes a valve needle coupling member in the form of a pull tube 64, which extends coaxially along the longitudinal axis L of the injector 10. The pull tube 64 defines an internal bore 66, which is shaped towards the lower end so as to define a relatively thick-walled portion 67 compared to the wall thickness along the remainder of the length of the pull tube 64. The relatively thick-walled portion 67 of the pull tube 64 defines an internal engagement surface 80 of frusto-conical form.

The first armature 52 and the second armature 60 are arranged on the pull tube 64, spaced apart along the pull axis L.

The first armature 52 is fixed to the pull tube 64, such that the motions of the first armature 52 and the pull tube 64 are coupled together. When the first coil 44 is energised, the first armature 52 is caused to move upwardly (in the illustration shown), hence pulling the pull tube 64 upwardly.

The second armature 60 is slidably mounted to the pull tube 64, in that the pull tube 64 is received within a central opening 63 of the second armature 60 in a sliding fit, such that the second armature 60 can move axially relative to the pull tube 64. When the second coil 54 is energised, engagement between a first thrust face that is fixed relative to the second armature 60 and a second thrust face that is fixed relative to the pull tube 64 transmits an upwardly acting force from the second armature 60 to the pull tube 64, to effect movement of the pull tube 64. Conversely, when the second coil 54 is not energised such that the second actuator arrangement 20b is inactive, the pull tube 64 can move relative to the second armature 60.

A lower end of the central opening 63 of the second armature 60 is enlarged to define a recess 65 within the second armature 60, which recess 65 accommodates a bearing sleeve 68 that is fixed to the second armature 60, for example by welding, interference fit, screw thread, adhesive or a combination of these approaches. The bearing sleeve 68 is generally tubular, aside from an annular end wall 69 that extends radially inwardly at a lower end of the sleeve 68. The end wall 69 includes a central opening that is sized for a sliding fit with the pull tube 64. A portion of a planar upper surface of the end wall 69 in the interior of the sleeve 68 defines the first thrust face 90.

Correspondingly, the second thrust face 91 is defined by a planar, radially-extending lower end face of an enlarged portion 92 of the pull tube 64, the enlarged portion 92 being received within the bearing sleeve 68. The enlarged portion 92 comprises a radially protruding tube flange 93 at its upper end, from an underside of which a downwardly-tapering conical portion 94 extends. The conical portion 94 terminates at a lower end surface extending in a radial plane, which surface defines the second thrust face 91. Accordingly, the second thrust face 91 is integral with the pull tube 64 in this example.

The underside of the tube flange 93 overhangs the conical portion 94, to define an upper spring seat for a thrust spring 95 disposed between the tube flange 93 and the end wall 69 of the bearing sleeve 68. Accordingly, a portion of the end wall 69 defines a lower spring seat, which surrounds the portion of the end wall 69 defining the first thrust face 90. The thrust spring 95 acts to bias the bearing sleeve 68 and the tube flange 93 apart, to hold the second armature 60 against the second bottom stop 89 when the second coil 54 is not energised, and in turn resists engagement between the thrust faces 90, 91.

The interface between the thrust faces 90, 91 is shown more clearly in the detail view provided in FIG. 1, which shows that when the second coil 54 is not energised the first and second thrust faces 90, 91 are spaced apart axially to define a small gap between them. Conveniently, the use of the bearing sleeve 68 as a separate component to define the first thrust face 90 enables the size of the gap to be adjusted according to the requirements of the application, for reasons that shall become clear in the description that follows.

The bearing sleeve 68 may be fabricated from a harder material than the second armature 60, thereby providing a correspondingly hard surface for the first thrust face 90.

It is possible for the first thrust face 90 to be defined by a surface of the second armature 60 itself in other embodiments, however.

It is noted that the thrust faces 90, 91 and the associated features are located at an axial position that lies between the flux paths that are generated by the coils 44, 54, when energised, which flux paths are represented by dashed lines in FIG. 1. Since the features that provide the thrust faces 90, 91 consume a substantial portion of the volume of the second armature 60, positioning these features away from the flux paths avoids restricting the flux area and so minimises the impact of accommodating the thrust faces 90, 91 on the performance of the actuator arrangements 20a, 20b.

An armature return spring 70 is mounted on a resting plate 71 carried at the upper end of the pull tube 64. The armature return spring 70 serves to urge the combined mass of the first armature 52, the second armature 60 and the pull tube 64 in a downwards direction towards an integral collar 72 on the valve needle 16.

At the upper end of the valve needle 16, remote from the tip 18, the valve needle 16 includes an upper stem 74 of reduced diameter directly above the integral collar 72, which extends into the pull tube 64. The upper stem 74 carries a tubular part in the form of a lift member 76 in an interference fit. A lower surface of the lift member 76 defines an engagement surface 81 which is shaped to cooperate with the engagement surface 80 on the pull tube 64. With the valve needle 16 seated against the valve seat 42, as shown in FIG. 1, the respective engagement surfaces 80, 81 of the lower region of the pull tube 64 and the lift member 76 are spaced apart by a separation distance, D. The lift member 76 may take any convenient form but in the illustration shown is an annular piece within which the upper end of the valve needle 16 is received.

The gap D between the engagement surface 80 of the pull tube 64 and the engagement surface 81 of the lift member 76 that comes into contact with the pull tube 64, such that the pull tube 64 may accelerate upwards to transmit an impact force to the valve needle 16, is shown more clearly in the lower enlarged portion of FIG. 1.

Because the pull tube 64 is a tubular component and defines the internal bore 66, it conveniently provides a flow path for the gaseous fuel through the middle of the injector 10. Fuel is introduced into the upper end of the housing 30 from a source of high pressure fuel. The fuel flows through and around the armature return spring 70 at the upper end of the pull tube 64 and onwards through the pull tube 64 itself. The pull tube 64 is provided with a plurality of holes 82 which extend radially through the wall of the tube 64 to define a flow path for fuel from the interior of the pull tube 64 into the spring chamber 38 and then onward to the downstream parts of the fuel injector 10. The valve needle 16 is provided with a plurality of grooves or flutes on its outer surface to permit fuel delivered to the nozzle body 14 to flow between the spring chamber 38 and the sac volume 22 when the valve needle 16 is lifted away from the seat region 42.

The nozzle spring 40 is operably engaged with the valve needle 16 via the spring seat 84. The upper stem of the valve needle 16 is received through nozzle spring 40 which provides a return force that acts on the valve needle 16, via the spring seat 84, urging it into the closed position in engagement with the seat region 42.

At its lower end, the nozzle spring 40 is mounted on a spring seat 84 which is formed from a collar carried on the integral collar 72 of the valve needle 16. The pull tube 64 is received within, and can slide relative to, the collar defining the spring seat 84. At the upper end of the nozzle spring 40, the end of the nozzle spring 40 engages with a lower abutment surface of a member defining a first bottom stop 86 for the first armature 52. The nozzle spring 40 presses the first bottom stop 86 into engagement with a support ring 87 that is fixed to the housing 30 beneath the first coil 44, the support ring 87 therefore preventing upward movement of the first bottom stop 86 such that the first bottom stop 86 is held in place against the support ring 87 by the nozzle spring 40.

The first bottom stop 86 is positioned beneath the first armature 52 to define a stop surface for the first armature 52 as it moves downwardly (in the illustration shown) under the force of the armature return spring 70. Because the first bottom stop 86 is conveniently held in place by the nozzle spring 40, this enables the first bottom stop 86 to absorb the impact from the first armature 52 when the nozzle valve needle 16 closes. There is a gap below the pull tube 64 when the armature 52 touches the first bottom stop 86.

The first bottom stop 86 is typically made of a material with damping properties, such as a polymer, to minimise armature bounce at the end of its travel. An annular ring 88 is mounted on the first bottom stop 86 to provide further damping when the first armature 52 is brought to a stop upon engagement with the first bottom stop 86. The annular ring 88 may also provide the function of a seal to prevent gas escaping from the injector 10. The annular ring 88 may be made of an elastomer material or any material with suitable damping properties. As described previously, whilst the first armature 52 is provided with the first bottom stop 86 to limit the extent of downward travel, the top stop for the first armature 52 is defined by the surface 61 of the first core member 46.

Correspondingly, a second bottom stop 89 is provided beneath the second armature 60, the second armature 60 being held in contact with the second bottom stop 89 by the thrust spring 95 when the second coil 54 is not energised. The second bottom stop 89 is defined by an annular member that is fixed to an upwardly directed surface of the lower region of the second core member 46b. Like the first bottom stop 86, the second bottom stop 89 is typically made of a material with damping properties, such as a polymer, to minimise armature bounce at the end of its travel. A radial clearance is provided between the bearing sleeve 68 and the second bottom stop 89, to ensure that the bearing sleeve 68 does not interfere with engagement between the second armature 60 and the second bottom stop 89.

FIG. 1 shows a gap between the underside of the bearing sleeve 68 and the upper surface of the lower region of the first core member 46b. This gap allows for downward movement of the pull tube 64 even when the second armature 60 is engaged with the second bottom stop 89. It follows that the interface between the first armature 52 and the first bottom stop 86 defines the point at which the pull tube 64 is stopped. Hence, the second actuator arrangement 20b and the second bottom stop 89 are configured to avoid interfering with the interface between the first actuator 52 and the first bottom stop 86, which therefore defines the primary control point for the pull tube 64.

The top stop surfaces 61, 62 are sized and dimensioned so that movement of the first and second armatures 52, 60 is stopped substantially at the same time when they are moved upwardly upon actuation of the actuator arrangements 20a, 20b.

FIG. 1 shows the injector 10 in a position in which the valve needle 16 is engaged with the valve seat 42 and therefore in its closed position. The armature return spring 70 pushes the pull tube 64 downwards, and hence the first armature 52 is engaged with the first bottom stop 86. In this position, no gaseous fuel is able to escape from the sac volume 22 through the outlets 24 as the valve needle 16 is seated against the valve seat 42.

The injector 10 can be operated in two different modes: a high-pressure mode, which is used when the pressure of fuel entering the injector 10 is above a pressure threshold, corresponding to the fuel tank being filled to at least a threshold filling level; and a low-pressure mode, which is used when the fuel pressure is below the pressure threshold, corresponding to the fuel tank being filled to a level below the threshold filling level. In this example, the pressure threshold may be approximately 150 bar, for example, although the threshold value may vary for each implementation.

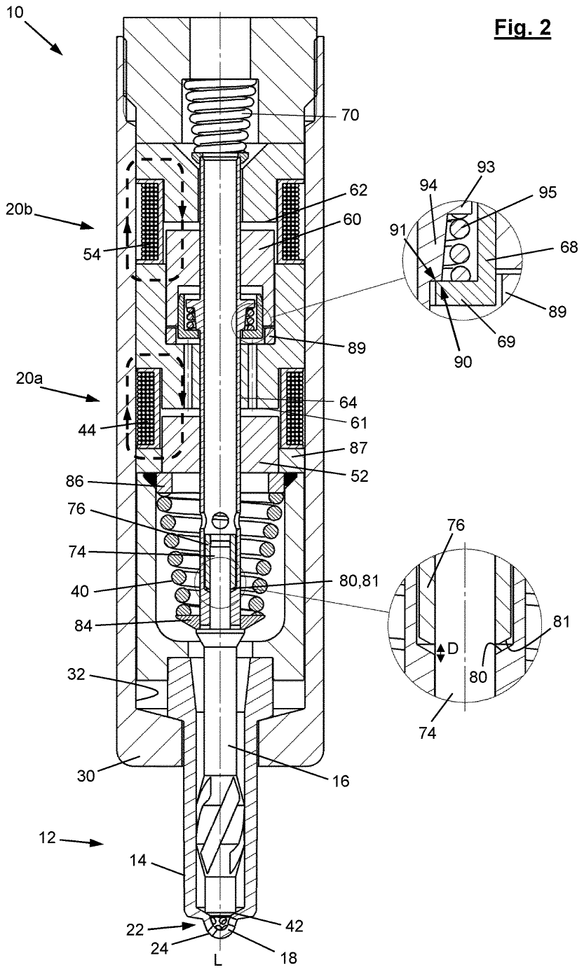

FIGS. 2 to 4 show a sequence of stages of a fuel injection operation of the injector 10 when in the high-pressure mode. In this mode, a current is applied to the first and second coils 44, 54, which generates magnetic flux that is controlled and guided by the first and second core members 46, 56 to cause electromagnetic forces to act on the armatures 52, 60. In turn, each armature 52, 60 transmits the force acting on it to the pull tube 64 once coupled to the pull tube 64. It follows that the first actuator arrangement 20a produces a first opening force that acts on the pull tube 64 through the first armature 52, and the second actuator arrangement 20b produces a second opening force that acts on the pull tube 64 through the second armature 60, once coupled.

Initially, only the first armature 52 is coupled to the pull tube 64, and the first opening force generated by the first actuator arrangement 20a is insufficient to overcome the opposing force provided by the armature return spring 70. At this stage, as FIG. 2 shows, the first armature 52 and the pull tube 64 remain stationary.

Meanwhile, the second armature 60, which is not yet coupled to the pull tube 64, is able to lift as the force generated by the second actuator arrangement 20b is sufficient to overcome the thrust spring 95. As the second armature 60 lifts, the first and second thrust faces 90, 91 come into engagement.

Once the thrust faces 90, 91 engage, the second armature 60 effectively becomes coupled to the pull tube 64 by way of the thrust faces 90, 91, and so the second opening force is applied to the pull tube 64 and therefore combined with the first opening force. At this stage, the first and second opening forces generated by both the first and second actuator arrangements 20a, 20b act on the pull tube 64 in combination so that the armatures 52, 60 are pulled upwards, together and simultaneously, against the force of the armature return spring 70. This combined force is sufficient to overcome the force of the armature return spring 70, and so the first and second armatures 52, 60 start to move in unison, causing the pull tube 64 to be drawn upwardly.

It follows from the above that the second opening force also acts to couple the second armature 60 to the pull tube 64, through the thrust faces 90, 91. Once coupled, the second opening force is then transmitted to the pull tube 64 from the second armature 60, through the interface between the thrust faces 90, 91, and in turn acts on the valve needle assembly.

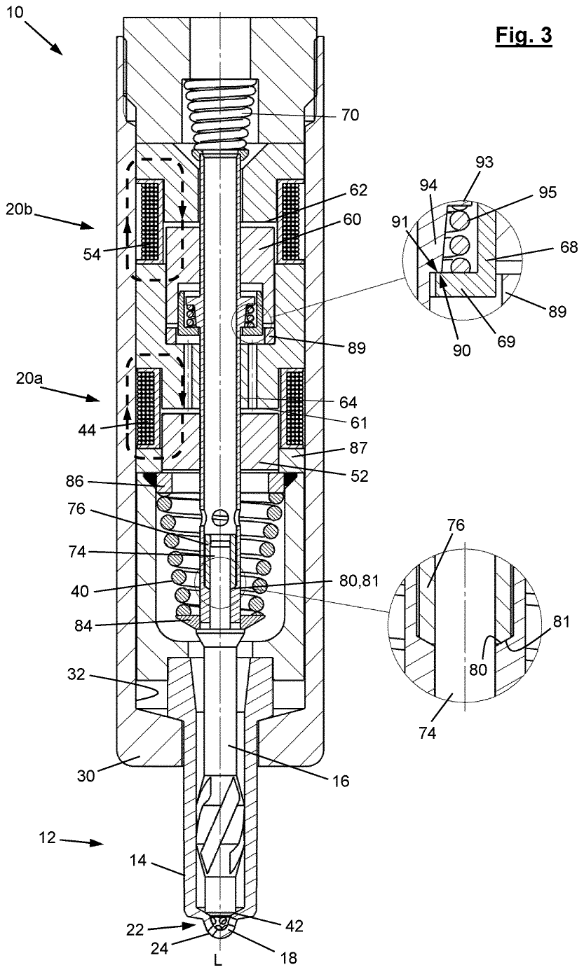

FIG. 3 shows the injector 10 at the point that the nozzle valve needle 16 is about to open. As the first armature 52 moves in an upward direction away from the first bottom stop 86, and the second armature 60 also moves upwardly, the armature return spring 70 is compressed and the gap, D, between the frusto-conical engagement surface 80 of the pull tube 64 and the engagement surface 81 of the lift member 76 on the valve needle stem 74 closes. The combined moving mass of the pull tube 64 and the first and second armatures 52, 60 is therefore brought into contact with the lift member 76. This transmits an impact force, or impulse, to the valve needle 16, via the engagement surfaces 80, 81, causing the valve needle 16 to move away from the valve seat 42 and through a lift stroke. This may be considered to be akin to a ‘hammer strike’ action. In this way, the combined first and second opening forces act on the valve needle 16 through the pull tube 64. As both armatures 52, 60 are moving at the point of impact when in the high-pressure mode, this can typically provide twice the impact force of a single armature.

The lift member 76 may be made of any material that can withstand the impact that is provided by a “hammer strike” upon lifting of the pull tube 64.

As the pull tube 64 continues to move through the lift stroke, the valve needle 16 moves further away from the valve seat 42. Once the valve needle 16 has moved away from the valve seat 42, gaseous fuel delivered to the sac volume 22 through the internal bore 66 of the pull tube 64 is able to flow out through the nozzle outlets 24.

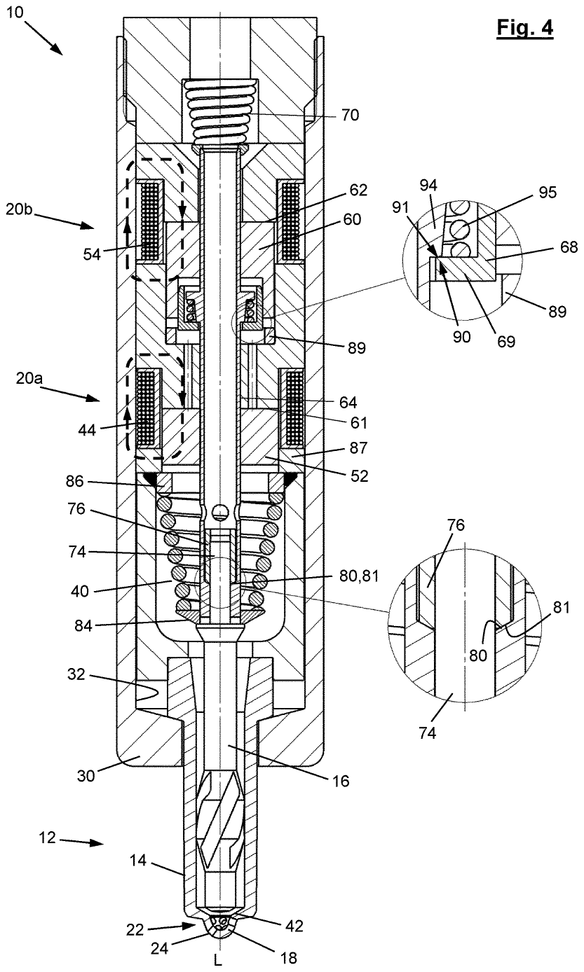

FIG. 4 shows the injector 10 at the point that the nozzle valve needle 16 is in the full lift position. Both the armature return spring 70 and nozzle spring 40 are compressed, with the nozzle spring 40 maintaining contact between the pull tube 64 and the lift member 76. Both the first armature 52 and the second armature 60 are in contact with their respective top stop surfaces 61, 62. Importantly, at this point the engagement surfaces 80, 81 are still engaged, coupling the pull tube 64 to the lift member 76 and therefore applying the combined first and second opening forces to the valve needle assembly.

It will therefore be appreciated from the foregoing description that throughout the full range of the lift stroke the frusto-conical engagement surface 80 of the pull tube 64 and the engagement surface 81 of the lift member 76 remain coupled together, until the end of stroke when the first armature 52 reaches its stop surface 61 and the second armature 60 reaches its stop surface 62. Because the lift member 76 and the pull tube 64 remain coupled together, the full available force from both the first and second actuator arrangements 20a, 20b therefore maintains the high force requirement throughout the full stroke of the valve needle 16 when the fuel pressure is high.

To generate a similar amount of force using a single solenoid actuator, a larger diameter would be required to provide a coil with more turns, which would increase the size and overall weight of the injector, and therefore increase the manufacturing costs and complexity of the injector. The use of two actuator arrangements is therefore highly desirable. It will be appreciated, however, that the present invention is not limited to first and second actuator arrangements. In other embodiments, more than two actuator arrangements may be used to generate the lift force required to lift the valve needle.

When fuel injection completes, the first and second coils 44, 54 are de-energised so that the valve needle 16, the pull tube 64 and the first and second armatures 52, 60 return to their rest positions under the action of the nozzle spring 40 and the actuator return spring 70. The injector 10 therefore resumes the state shown in FIG. 1.

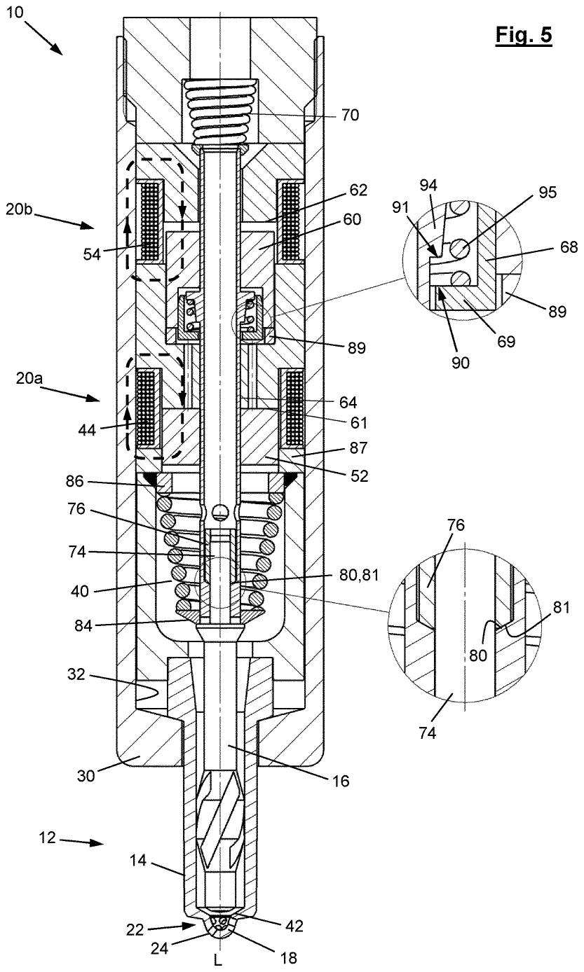

Turning to FIG. 5, when the fuel pressure is below the pressure threshold the force required to lift the valve needle 16 from its seat 42 is correspondingly lower. In this situation, the first opening force produced by the first actuator arrangement 20a is sufficient to lift the valve needle 16. Operating both of the first and second actuator arrangements 20a, 20b would therefore generate a higher lift force than required to lift the valve needle 16, in turn imparting excess kinetic energy to the valve needle 16.

Accordingly, only the first actuator arrangement 20a is used in the low-pressure mode. Since the second armature 60 is not permanently coupled to the pull tube 64, the second armature 60 can be decoupled from the pull tube 64 so that the first actuator arrangement 20a does not need to lift the mass of the second armature 60. Since coupling engagement between the second armature 60 and the pull tube 64 is effected by way of the second opening force, deactivating the second actuator arrangement 20b effectively decouples the second armature 60 from the pull tube 64, to allow the pull tube 64 to move relative to the second armature 60.

In this respect, FIG. 5 shows the valve needle 16 at full lift, but with the second armature 60 remaining engaged with the second bottom stop 89 under the action of the thrust spring 95, and therefore decoupled from the pull tube 64. As the pull tube 64 has been lifted upwards, the separation between the thrust faces 90, 91 has increased relative to when the injector 10 is in the closed position shown in FIG. 1.

By operating only the first actuator arrangement 20a in the low-pressure mode, only the first opening force is applied to the valve needle 16. The total force acting on the valve needle 16 is therefore lower than the combined first and second opening forces generated in the high-pressure mode, such that the kinetic energy imparted to the valve needle 16 as it lifts is reduced. In turn, the valve needle 16 tends to bounce to a lesser extent when it reaches full lift, enhancing control over fuel injection.

As the second armature 60 is decoupled from the pull tube 64 in the low-pressure mode, the total mass of the impacting features when the first armature 52 engages its stop surface 61 is reduced, in turn reducing noise.

Another benefit of the low-pressure mode is that the electrical power consumed by the injector 10 is reduced, since only the first coil 44 is energised.

In summary, the provision of a second armature 60 that can couple to the pull tube 64 selectively via thrust faces 90, 91 enables the fuel injector 10 to apply a variable opening force to the valve needle 16 via the pull tube 64, and therefore reduce excess kinetic energy in the valve needle 16 when the fuel pressure is low. Advantageously, this is achieved without altering control of the actuator arrangements 20a, 20b, when active, noting that slowing operation of the actuator arrangements may complicate control.

The actuator arrangements 20a, 20b can have their coils wired in series or in parallel and driven by a single electrical circuit, saving cost on the electronics compared to driving two coils separately. Suitable switching can then be provided to enable the second coil 54 to be deactivated when the first coil 44 is energised in the low-pressure mode. Alternatively, each actuator arrangement may be provided with a separate drive circuit.

As noted earlier, the size of the gap between the thrust faces 90, 91 when the injector 10 is at rest, when the first and second coils 44, 54 are not energised, can be varied by altering the position of the bearing sleeve 68 relative to the second armature 60. In some embodiments, the bearing sleeve 68 may be positioned so that the thrust faces 90, 91 are engaged when the coils 44, 54 are not energised. In other embodiments, the gap between the thrust faces 90, 91 may be smaller or larger than is shown in FIG. 1. The size of the gap influences the kinetic energy in the second armature 60 at the moment when the thrust faces 90, 91 engage during a fuel injection event, and therefore the force of the impact between the thrust faces 90, 91. This impact force may provide a hammer effect to aid opening of the valve needle 16 and so may be desirable in some applications. Accordingly, the size of the gap between the thrust faces 90, 91 may be altered to provide a desired impact force.

It will be appreciated that various other embodiments of the invention are also envisaged without departing from the scope of the appended claims.

For example, in other embodiments, a solid cylindrical body may be used instead of a coupling member in the form of a pull tube. In this case the flow path may be defined radially around the body, and/or by means of passages drilled through the solid cylindrical body, and the flow path may be continued by passages formed in the first and second core members and/or the first and second armatures.

Selective coupling between an armature and a coupling member such as a pull tube may be implemented in various ways other than using interfacing thrust faces, as in the example described above. Also, where thrust faces are used, these can be implemented in various other ways. For example, thrust faces could be frusto-conical, instead of planar as in the above example. Also, the second thrust face may not be integral with the pull tube as in the above example, and may instead be provided by a separate component such as a collar that is fixed relative to the coupling member.

In other examples, more than one armature is arranged for selective coupling with a coupling member such as a pull tube. This may be particularly useful where two or more actuator arrangements are dissimilar and arranged to generate differing lift forces that act on the valve needle, thereby creating further flexibility in the lift force applied to the valve needle. For example, in an arrangement having two actuator arrangements with armatures that can be coupled selectively, three distinct lift forces can be generated.

The engagement surfaces 80, 81 are not limited to the frusto-conical shape as described in the present invention. Other embodiments may have an altered shape of the engagement surface 80, 81 shown in the accompanying Figures such that the surfaces of the pull tube 64 and the lift member are angled differently, ranging from being completely perpendicular to the pull tube axis L to being near parallel.

### LIST OF PARTS

10—fuel injector
12—injection nozzle
14—nozzle body
16—valve needle
18—nozzle tip
20a—first actuator arrangement
20b—second actuator arrangement
22—sac volume
24—nozzle outlet(s)
26—nozzle bore
28—shoulder region of the nozzle body
30—tubular housing
32—internal bore of the tubular housing
34—opening of the tubular housing
36—head end of the nozzle body
37—insert
38—spring chamber
40—nozzle spring
42—valve seat region
44, 54—first and second coils
46, 56—first and second core members
46a, 56a—upper region of first and second core members
46b, 56b—lower region of the first and second core members
47, 57—first and second coil-formers
52, 60—first and second armatures
61, 62—stop surfaces of the first and second armatures
63—central opening of second armature
64—pull tube (valve needle coupling member)
65—second armature recess
66—internal bore of the pull tube
67—thick-walled portion of pull tube
68—bearing sleeve
69—end wall of bearing sleeve
70—armature return spring
71—resting plate
72—integral collar of the valve needle
74—upper stem of the valve needle
76—lift member
80—engagement surface of the pull tube
81—engagement surface of the lift member
82—pull tube hole
84—spring seat
86—first bottom stop
87—support ring
88—annular ring
89—second bottom stop
90—first thrust face
91—second thrust face
92—enlarged portion of pull tube
93—tube flange
94—conical portion
95—thrust spring
D—separation distance

1. A fuel injector for delivering gaseous fuel to an internal combustion engine, the fuel injector comprising:
an injection nozzle comprising a nozzle body provided with a nozzle bore;
a valve needle assembly received within the nozzle bore and including a valve needle engageable with a seat region to control gaseous fuel delivery through at least one outlet of the injection nozzle;
a valve needle coupling member that is engageable with the valve needle assembly to cause an opening movement of the valve needle;
a first actuator that is operable to produce a first opening force that acts on the valve needle assembly through engagement between the first actuator and the valve needle coupling member; and
a second actuator that is operable to produce a second opening force that acts on the valve needle assembly through engagement between the second actuator and the valve needle coupling member;
wherein the valve needle coupling member is movable relative to the second actuator when the second actuator is inactive;
and wherein the valve needle coupling member defines a separation distance with an engagement surface of the valve needle assembly so that the valve needle coupling member only impacts the engagement surface when the valve needle coupling member has moved through the separation distance following actuation, and whereby the valve needle coupling member and the engagement surface remain engaged through a full range of movement of the valve needle to a full lift position.

2. The fuel injector of claim 1, wherein the second actuator is configured so that the second opening force urges the second actuator into engagement with the valve needle coupling member.

3. The fuel injector of claim 1, wherein the second actuator comprises a first thrust surface that is configured to engage a second thrust surface that is fixed relative to the valve needle coupling member.

4. The fuel injector of claim 3, wherein valve needle coupling member comprises the second thrust surface.

5. The fuel injector of claim 1, wherein the second actuator comprises a second armature, and wherein the valve needle coupling member is movable relative to the second armature when the second actuator is inactive.

6. The fuel injector of claim 3, wherein the first thrust surface is fixed relative to the second armature.

7. The fuel injector of claim 1, wherein the second actuator is configured to decouple from the valve needle coupling member when inactive.

8. The fuel injector of claim 1, wherein the first actuator is fixed to the valve needle coupling member.

9. The fuel injector of claim 1, wherein the first actuator comprises a first armature that is carried by the valve needle coupling member.

10. The fuel injector of claim 9, comprising a first stop member (86) which defines a first stop surface with which the first armature is brought into engagement when the valve needle is brought to close against the seat region.

11. The fuel injector of claim 10, wherein the first stop member further defines an abutment surface for a spring that serves to urge the valve needle against the seat region to close the valve needle when the first actuator and the second actuator are de-actuated.

12. The fuel injector of claim 1, wherein the valve needle coupling member is a pull tube within which a portion of the valve needle is received.

13. The fuel injector of claim 12, wherein the pull tube defines a flow path for gaseous fuel through the injection nozzle.

14. The fuel injector of claim 12, wherein the pull tube is provided with at least one opening to allow gaseous fuel flowing within the pull tube to flow radially out through the pull tube for delivery to downstream parts of the injection nozzle.

15. The fuel injector of claim 1, wherein the valve needle coupling member defines an internal engagement surface which is engageable with the engagement surface of the valve needle assembly.

16. A method of operating a fuel injector for delivering gaseous fuel to an internal combustion engine, the fuel injector comprising:
an injection nozzle comprising a nozzle body provided with a nozzle bore;
a valve needle assembly received within the nozzle bore and including a valve needle engageable with a seat region to control gaseous fuel delivery through at least one outlet of the injection nozzle; and
a valve needle coupling member that is engageable with the valve needle assembly to cause an opening movement of the valve needle, wherein the valve needle coupling member defines a separation distance with an engagement surface of the valve needle assembly so that the valve needle coupling member only impacts the engagement surface when the valve needle coupling member has moved through the separation distance following actuation, and whereby the valve needle coupling member and the engagement surface remain engaged through a full range of movement of the valve needle to a full lift position; wherein the method comprises:
operating a first actuator of the injector to produce a first opening force that acts on the valve needle assembly through engagement between the first actuator and the valve needle coupling member;
when a pressure of fuel exceeds a pressure threshold, operating a second actuator of the injector to produce a second opening force that acts on the valve needle assembly through engagement between the second actuator and the valve needle coupling member; and
when a pressure of fuel is below the pressure threshold, moving the valve needle coupling member relative to the second actuator.
